(19) United States
(12) Patent Application Publication
(10) Pub. No.: US 2007/0038337 A1
(43) Pub. Date: Feb. 15, 2007

(54) Method for operating a network

(75) Inventors: Joachim Hofmann, Winnenden (DE); Anja Kuhn, Fellbach (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/502,454

(22) Filed: Aug. 11, 2006

(30) Foreign Application Priority Data
Aug. 12, 2005 (DE) 102005038183.9

(51) Int. Cl. G06F 17/00

(52) U.S. Cl. 701/1

(57) ABSTRACT

In a method for operation of a network comprising a plurality of networked controllers in a vehicle, controller groups are each formed from a plurality of controllers, and are designed to carry out various vehicle functions. One of the controllers in each controller group is configured as a function master controller which stores all data relevant for the vehicle function associated with this controller group. A central controller communicates with all of the function master controllers, and stores the data from all of the function master controllers using a global variant coding (GVC). In addition, the central controller transmits a global status message (GSM) in the network, which message comprises a status signal (GSS) that signals whether a change has occurred in the GVC, and at least some of the GVC. All of the active controllers carry out an update, if necessary, by access to the GVC, of all the data which is relevant for the respective controller when the GSM signals a desired GVC.

This application claims the priority of German patent document 102005038183.9, filed Aug. 12, 2005, the disclosure of which is expressly incorporated by reference herein.

The present invention relates to a network and to a method for operating a network comprising a plurality of networked controllers in a vehicle, in particular in a commercial vehicle.

Modern vehicles have a large number of different functions, with controllers being provided to carry out most of the functions. Moreover, individual vehicles are normally manufactured with different equipment variants or function variants. For example, a commercial vehicle of a particular type may have different engine systems and different numbers of axles in the various equipment variants. Certain vehicle types may in fact have more than one million variants.

At the same time, vehicle manufacturers are attempting to reduce the costs by using the same controllers in different vehicle types, and in different vehicle variants. In order to allow the controllers to carry out correctly the functions associated with them, they must know specific vehicle data or function data items that are expediently stored in the controllers. The individual controllers can use the data that is relevant for them from the large volume of data that is sent in the network by means of an intensive data interchange. This results in an extremely high data flow, at least when starting up the network, which can have a considerable adverse effect on the data transmission speed in the network in the case of large networks which have a large number of controllers. This high data flow rate endangers the functional reliability of the network.

German patent document DE 102 19 832 A1 discloses a method for coding of controllers in vehicles which are produced in various equipment variants. The controllers are appropriately configured to adapt them to different vehicle variants. For this purpose, identification information is stored for each of the various equipment variants of the vehicle. In the known method, the respective controller is configured by storing the configuration data of the controllers in an equipment variant controller for different equipment variants. For configuration to a specific equipment variant of the vehicle, the controller to be configured transmits identification information to the equipment variant controller, which uses it and the data stored in the equipment variant controller to collate the data for configuration of the controller to be configured. The data collated in this way is written to the memory for the controller to be configured, so that this controller is configured to the desired equipment variant.

One object of the present invention is to reduce the load that is imposed on the network by data transport (traffic), for a network comprising a plurality of networked controllers in a vehicle.

This and other objects and advantages are achieved by the network and method according to the invention, which is based on the general idea of arranging a central hierarchy level between a central controller, in which all of the relevant data of the vehicle is provided in the form of a global variant coding (GVC), and the individual controllers associated with the various functions, in which hierarchy level function master controllers are arranged, each of which contains all of the data that is relevant for provision of a specific vehicle function.

Controller groups are formed for this purpose, each comprising a plurality of controllers that interact in order to provide a specific vehicle function. One controller from this controller group is then configured as the function master controller. The central controller now needs communicate only with the function master controllers in order to obtain an overview of all the controllers and the vehicle functionalities which can be provided by them.

The central controller generates and updates the GVC using, inter alia, the data for the function master controllers at a central point, and transmits a global status message (GSM) in the network, which comprises at least one global status signal (GSS) in order to signal a change in the GVC, or at least a part of the GVC.

All of the active controllers can now automatically identify on the basis of the GSS whether the GVC has changed and whether an update may be necessary to the data which is relevant for the respective controller. The controllers can then automatically update the data that is relevant for them either in each case, by accessing that part of the GVC which is comprised by the GSN and/or the GVC of the central controller, or only when a previous check has shown that the respective change in the GVC is also relevant for that respective controller.

The multilayer structure of the controllers within the network allows the data traffic in the network to be reduced significantly, particularly when starting up the network. In a corresponding manner, this reduces the load on the network, speeds up the data transmission, and the network operates in a more stable manner.

It is self-evident that the features mentioned above and those which are still to be explained in the following text can be used not only in the respectively stated combination but also in other combinations or on their own, without departing from the scope of the present invention.

Other objects, advantages and novel features of the present invention will become apparent from the following detailed description of the invention when considered in conjunction with the accompanying drawings.

### BRIEF DESCRIPTION OF THE DRAWINGS

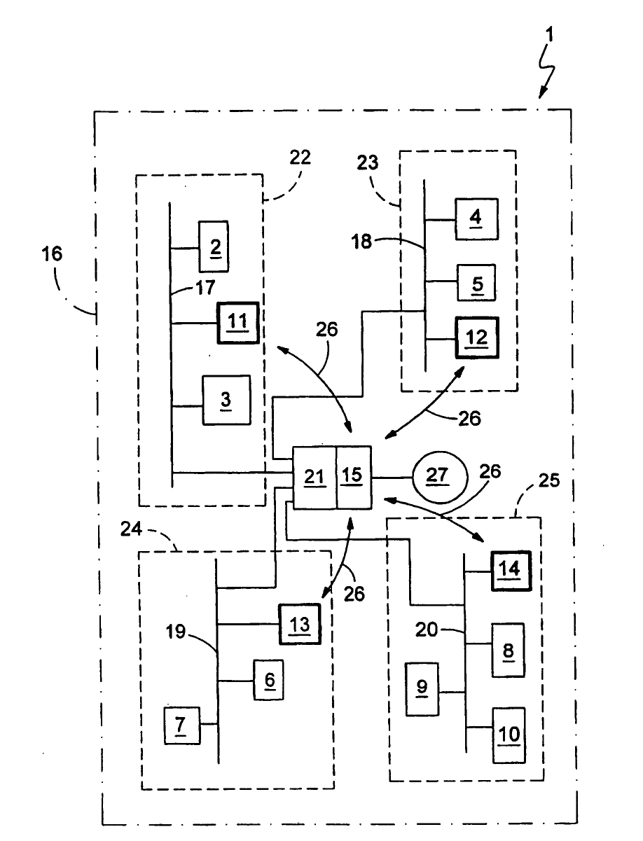

The single FIG. 1 is a highly simplified schematic diagram of a preferred embodiment of the network according to the invention.

### DETAILED DESCRIPTION OF THE DRAWINGS

As shown in FIG. 1, a network 1 comprises a large number of controllers 2 to 15 which are networked with one another. The network 1 and the controllers 2 to 15 are in this case arranged in a vehicle 16 (preferably a commercial vehicle), which is indicated here by a box surrounded by dashed-dotted lines. The vehicle 16 can be manufactured with different equipment variants. Equipment variants in this case comprise on the one hand the equipment of the vehicle 16 with different functions, such as an air-conditioning system, all-wheel drive, ABS, ESP, ABC and so forth. On the other hand, equipment variants may also differ from one another by having different types of components, such as vehicle axles, engine, gearbox and the like. The controllers 2 to 15 are used to provide various vehicle functions. For this purpose, they require on the one hand information about the functionalities which the equipment of the respective vehicle 16 comprises. On the other hand, at least some of the controllers (for example, an engine controller) require information about the components provided within the equipment variant of the respective vehicle 16.

In order to allow the information interchange which is required for this purpose, the controllers 2 to 15 are networked with one another. For this purpose, the network 1 comprises a plurality of buses 17 to 20, to which the controllers 2 to 15 are connected. The buses 17 to 20 in turn are connected to one another via a central gateway 21, to which the buses 17 to 20 are connected in a suitable manner. (Suitable bus systems include, for example, CAN, MOST or FlexRay.)

In the network 1 according to the invention, a plurality of controller groups 22 to 25 are formed which are in this case each symbolized by boxes surrounded by dashed lines. Each controller group 22 to 25 comprises a plurality of controllers 2 to 14, and each is associated with one vehicle function. This means that the controllers in each controller group 22 to 25 are associated with a common vehicle function, and interact to provide that function. For example, a plurality of controllers are involved in the provision of the “internal air-conditioning” function, for example controllers for operation of a fan, of a heating device, of a cooling device, of a pump for driving a heat transmission means. Each controller group 22 to 25 has a different associated vehicle function.

In the network 1 according to the invention, one of the controllers within each controller group 22 to 25 is designed or configured as a function master controller. The controller 11, for example, is the function master controller 11 from the controllers associated with the controller group 22, while the controller 12 is configured as the function master controller 12 from the associated controllers in the controller group 23. In controller group 24, which comprises the controllers 6, 7 and 13, the controller 13 is the function master controller 13. Finally, the controller group 25, the controller 14 operates as the function master controller 14.

In the architecture of the network 1 shown in the FIGURE, the individual controller groups 22 to 25 are arranged randomly on different buses 17 to 20. A plurality of controller groups 22 to 25 can obviously also be arranged on the same bus 17 to 20.

Within the respective controller groups 22 to 25, the function master controllers 11-14 differ from the other controllers 2 to 10, in that, on the one hand, all of the data which is relevant for provision of the vehicle function associated with the respective controller group is stored in the respective function master controller 11 to 14. Thus, for example, the controller identifiers of the other controllers 2 to 10 in the respective controller group 22 to 25 are stored in the respective function master controller 11 to 14. On the other hand, during normal operation, a central controller 15 communicates exclusively with the function master controllers 11 to 14, via the network (that is, via the buses 17 to 20 and the central gateway 21). Double-headed arrows 26 are shown in FIG. 1 in order to visualize this preferred communication, and symbolize the communication between the central controller 15 and the function master controllers 11 to 14.

The central controller 15 gathers the data from all of the function master controllers 11 to 14 and adds them to a global variant coding (GVC). The central controller 15 expediently stores the GVC in a central memory 27, to which it is connected in a suitable manner. The central controller 15 is expediently arranged at or in the central gateway 21, thus making it easier for the central controller 15 to communicate with the other controllers 2 to 14 via the various buses 17 to 20.

In principle, the vehicle 16 may also have a functionality whose provision requires only a single controller. In this case, no controller group is associated with this vehicle function; rather, only a single controller, which for the purposes of the present invention then forms a function master controller since it necessarily contains all of the relevant data which is required for provision of the associated vehicle function.

The network 1 according to the invention is preferably operated as follows:

When the network is active, the central controller 15 transmits a global status message (GSM) in the network 1. This GSM comprises a least one global status signal (GSS) as well as at least some of the data of the GVC. The GSS is a one-bit signal or flag, which is either set (bit signal 1) or is not set (bit signal 0). The GSS signals whether or not a change has taken place in the GVC since the last transmission of the GSM.

The GSM, which is in particular transmitted cyclically, can be tapped off by all of the controllers 2 to 14, which are designed or programmed such that they automatically check the GSS transmitted with the GSM when in the activated state. Each individual controller 2 to 14 can easily find out in this way whether the GVC has or has not been changed since the last transmission of the GSM.

If the respective controller 2 to 14 finds that the GSS is set (that is, there is a changed GVC), the respective controller 2 to 14 can automatically update all of the data which is relevant for that respective controller. In this case, the individual controllers 2 to 14 can in principle use different updating strategies. For example, a controller may always carry out such an update when there is a changed GVC, irrespective of whether the change in the GVC is or is not at all relevant to the particular controller. However, it is also possible that, once the controller has found that there is a change in the GVC, it first checks whether change is or is not relevant for that particular controller, and automatically carries out the update only if the change in the GVC is relevant.

The GVC comprises different data types. For example, a first data type (or first data items) transmitted with the GSM comprises, for example, the current version number of the GVC. Furthermore, a second data type can be provided which comprises second data items, which can be specifically checked by individual controllers 2 to 14. For example, a gearbox controller requires information about the type of gearbox fitted. Finally, a third data type can be provided, whose third data items can be checked only by an external tester. For example, the vehicle make and vehicle type are of no interest to the controllers 2 to 15 while, for example, this information may be important for a workshop.

If the GSM includes the current version number of the GVC within the GVC data transmitted with it, the respective controller 2 to 14 in one specific embodiment can check whether the internally stored version number is older than the current version number of the GVC. If so, it automatically carries out an update, by accessing the GVC.

In principle, in the update mode, communication can also take place between the central controller 15 and the respective controller 2 to 14, which need not necessarily be a function master controller 11 to 14. The data which are relevant for the respective controllers 2 to 14 are updated by means of the update.

This configuration results in the network 1 being automatically configured when the equipment in the vehicle 16 is changed. In this case, for example, an equipment change may be the retrofitting of a new functionality or of a new vehicle component, in the same way as the removal of a functionality or vehicle component which is no longer required. Furthermore, a change takes place in the vehicle equipment when worn-out or defective components or controllers are replaced by new components or controllers, respectively.

Changes such as these in the vehicle equipment may in some cases be identified automatically by the central controller 15, so that the central controller 15 automatically updates the GVC as appropriate. Other equipment changes may not be identified automatically by the central controller 15 and must therefore be read in via an appropriate interface (not shown). In this case as well, the GVC is updated, and this is automatically disseminated by setting the GSS in the network 1. In this case, the entire data stream is comparatively small, since the central controller 15 need not check the data for the individual functions with all of the controllers 2 to 14, but must communicate only with the function master controllers 11 to 14 for this purpose.

In addition to specific controller parameters, the GSM may in this case additionally comprise further information from the GVC database, such as the current version number of the GVC, the vehicle make, the vehicle type, the vehicle version and a vehicle identification number, as well as a list of the identifiers of all the controllers 2 to 15 in the network 1.

Since, as explained above, the vehicle data cannot all be recorded via controllers 2 to 14, the GVC may also comprise vehicle data which is not stored in any of the function master controllers 11 to 14. For example, vehicle axles are currently not associated with controllers, so that the number of axles on the vehicle, which may vary to a major extent particularly in the case of commercial vehicles, is an information item which must be read into the central controller 15 when the vehicle 16 is equipped with the axles. The central controller 15 then likewise adds this vehicle data to the GVC. This vehicle-specific data may be relevant for a number of functionalities of the vehicle 16, and thus for a number of the controllers 2 to 14, and is made available to them by the GVC.

The GVC can also be used to store bus data, such as the respective bus type, the baud rate which can be transmitted and the respective bus protocol. Furthermore, the GVC may also include controller data from all of the controllers 2 to 15 which are networked in the network 1. These controller data comprise, for example, the respective controller address, information about whether the respective controller 2 to 14 is provided or whether the respective controller 2 to 14 is monitored by the central gateway 21. Furthermore, the association between the respective controller 2 to 14 and one of the buses 17 to 20 can be stored. Diagnostic records of the respective controllers 2 to 14 and diagnostic versions may be included in the controller data, as well as hardware part numbers and/or software part numbers of the respective controller 2 to 14, as well as a system identifier of the respective controller 2 to 14.

In order to avoid excessive increases in the amount of data traffic in the network 1 when individual controllers 2 to 14 must carry out an update, the respective update or the check of data from the GVC can be carried out via a diagnostic channel between the central controller 15 and the respective controller 2 to 14. This diagnosis channel is free of general data traffic, and is used for transmission of diagnosis records and for carrying out diagnostic procedures. Moving the updates of the individual controllers 2 to 14 to the diagnostic channel thus reduces the amount of traffic on the channels which are intended for general data interchange. In principle, the GSM can also be transmitted via such a diagnostic channel.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for operation of a network comprising a plurality of networked controllers in a vehicle, in which individual controllers or controller groups which are each formed from a plurality of interacting controllers are configured to carry out different vehicle functions, said method comprising:
Configuring one of the controllers in each particular controller group as a function master controller which stores all data relevant for the vehicle function associated with the particular controller group;
a central controller communicating with all function master controllers, and adding the data received from all of the function master controllers to a stored global variant coding (GVC);
the central controller transmitting a global status message (GSM) in the network, which message comprises at least one global status signal (GSS) and at least some data from the GVC, the GSS indicating whether or not a change has occurred in the GVC since a last transmission of the GSM;
all active controllers automatically accessing at least that part of the GVC which is comprised by the GSM when the GSS signals a change to the GVC; and
each active controller carrying out an update of all data relevant to that controller according to one of the following:
i) in response to every GVC, and
ii) only when a previously carried out test indicates that the change to the GVC is relevant for that controller.

2. The method according to claim 1, wherein the GZN comprises at least one of the following information items:
current version number of the GVC;
vehicle make;
vehicle type;
vehicle version;
vehicle identification number; and
list of identifiers of all of the controllers in the network.

3. The method according to claim 1, wherein at least one of the following is true:
the GVC also comprises vehicle data which is not stored in any of the function master controllers;
the GVC also comprises data from vehicle components or vehicle assemblies which have no associated controller;
the GVC comprises first data items which are transmitted with the GSM, and second data items which can be specifically checked by individual controllers, as well as third data items which can be checked only by means of an external tester;
the GVC also comprises bus data, including at least one of type, baud rate and protocol of the bus;
the GVC also comprises controller data for all of the controllers; and
the GVC comprises at least one of a controller address, information as to whether a respective controller is present and/or is monitored by a central gateway, bus association of the respective controller, diagnosis protocol of the respective controller, diagnosis version, hardware part number of the respective controller, software part number of the respective controller, and system identifier of the respective controller.

4. The method according to claim 1, wherein a diagnosis channel in the respective bus or in the network is used for transmission of the GSM and/or for checking data from the GVC between the central controller and the respective controller.

5. The method according to claim 1, wherein the GSM is transmitted cyclically in the network.

6. The method according to claim 1, wherein one controller compares current version numbers of other controllers with most recently and internally stored version numbers for the respective controllers, and updates all relevant data by access to the other controllers if the most recently stored version number in the respective controller is older than the current version number in this controller.

7. A network in a vehicle comprising:
a plurality of networked controllers;
at least one bus to which the controllers are coupled; and
a central controller; wherein
individual controllers or controller groups formed from a plurality of interacting controllers are configured to carry out different vehicle functions;
one controller in each controller group is configured as a function master controller, which stores all data relevant for the vehicle function associated with the particular controller group;
the central controller is configured to communicate with all function master controllers and adds data received from all of the function master controllers to a stored global variant coding (GVC);
the central controller is configured to transmit a global status message (GSM) in the network, which message comprises at least one global status signal (GSS) and at least some data from the GVC, the GSS indicating whether or not a change has occurred in the GVC since a last transmission of the GSM;
all active controllers are configured such that they automatically access at least that part of the GVC which is comprised by the GSM when the GSS signals a change to the GVC; and
each active controller carries out an update of all data relevant to that controller, and carries out an update according to one of the following:
i) in response to every GVC; and
ii) only when a previously carried out test indicates that the change to the GVC is relevant for that controller.

8. The network according to claim 7, wherein the controllers are networked with one another via a plurality of buses, which are connected to one another via a central gateway.

9. The network according to claim 8, wherein the central controller is arranged in or at the central gateway.

10. The network according to claim 7, wherein the central controller communicates with a central data memory in which the data of the GVC is stored.

11. The network according to claim 7, wherein one controller compares current version numbers of other controllers with a most recently and internally stored version number for the respective controller, and updates all relevant data by access to the other controllers if the most recently stored version number in the respective controller is older than the current version number in this controller.
